(19) United States
(12) Patent Application Publication
(10) Pub. No.: US 2019/0227775 A1
(43) Pub. Date: Jul. 25, 2019

(54) MOBILE ROBOT INCLUDING PROGRAMMABLE INPUT MODULE

(71) Applicant: HELLOGEEKS Inc., Seoul (KR)

(72) Inventors: Byeong Wol KIM, Seoul (KR); Jae Young KIM, Anyang-si (KR); Shin Young RHEE, Seoul (KR)

(73) Assignee: HELLOGEEKS Inc., Seoul (KR)

(21) Appl. No.: 16/047,692

(22) Filed: Jul. 27, 2018

(30) Foreign Application Priority Data
Jan. 24, 2018 (KR) 10-2018-0008891
Feb. 1, 2018 (KR) 10-2018-0012623

(51) Int. Cl. G06F 8/34; G05D 1/00; G09B 19/00; G06F 3/0482

(52) U.S. Cl. CPC G06F 8/34; G06F 3/0482; G09B 19/0053; G05D 1/0016

(57) ABSTRACT

Disclosed is a mobile robot. The mobile robot including a programmable input module includes a processor controlling the mobile robot, an input module receiving a command for programming the mobile robot from a user, a sensor module sensing an ambient change of the mobile robot, and an operation module operating depending on the action command input from the input module when the processor executes a command sequence including a command input from the input module. The control command includes a repeat command, and the processor repeats the execution of the action command input from the input module before the repeat command is input.

### CROSS-REFERENCE TO RELATED APPLICATIONS

A claim for priority under 35 U.S.C. § 119 is made to Korean Patent Application Nos. 10-2018-0008891 filed on Jan. 24, 2018 and 10-2018-0012623 filed on Feb. 1, 2018, in the Korean Intellectual Property Office, the entire contents of which are hereby incorporated by reference.

### BACKGROUND

Embodiments of the inventive concept described herein relate to a mobile robot including a programmable input module, and more particularly, relate to a programmable mobile robot using an input module provided by a mobile robot, even though a separate device is not used.

In the era of the fourth industrial revolution, there is a growing demand for software engineers such as engineers who can do programming. While programming education is required throughout the society, the programming education has been adopted as an elementary curriculum because creativity and logicality is improved through the programming education.

Since the conventional programming education method is performed through a general programming language such as C/C++, BASIC, Assembly, and Java, a level of knowledge equivalent to a professional programming level was required. However, this method is only suitable for semi-specialist programming education for adolescents, and thus, the programming education method is not suitable for children, especially for preschoolers or children in lower grades.

Accordingly, the programming education methods and tools suitable for children are continuously being developed.

In the meantime, for the purpose of increasing the interest in the programming education, the programming education is performed using a robot. However, referring to conventional programming education methods and tools, since a programming device and a robot are separated and the device is complicated or the conventional programming device is merely coupled to the robot even though the programming device and the robot are integrated, it is difficult for children to intuitively understand programming. Therefore, the development of programming education methods and education tools suitable for children is urgently required.

### SUMMARY

Embodiments of the inventive concept provide a programmable mobile robot using an input module provided by a mobile robot, even though a separate device is not used.

Embodiments of the inventive concept provide a mobile robot capable of intuitively understanding commands for programming and programming rules in the course of performing programming using an input module.

According to an aspect of an embodiment, a mobile robot including a programmable input module includes a processor controlling the mobile robot, an input module receiving a command for programming the mobile robot from a user, a sensor module sensing an ambient change of the mobile robot, and an operation module operating depending on the action command input from the input module when the processor executes a command sequence including a command input from the input module. The control command includes a repeat command, and the processor repeats the execution of the action command input from the input module before the repeat command is input. The command for programming includes an action command associated with an operation of the mobile robot, a condition command associated with a condition for executing the action command, and a control command for controlling a command input to the mobile robot. The processor determines whether the condition for executing the action command is satisfied, based on the sensed result of the sensor module.

Other specific details of the inventive concept are included in the detailed description and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram illustrating a configuration of a mobile robot, according to an embodiment of the inventive concept;

FIG. 2 is a perspective view of a mobile robot, according to an embodiment of the inventive concept;

FIG. 3 is a schematic diagram of an input module of a mobile robot, according to an embodiment of the inventive concept;

FIG. 4 is a block diagram illustrating a configuration of a sensor module of FIG. 1;

FIG. 5 is a block diagram illustrating a configuration of a mobile robot, according to another embodiment of the inventive concept; and

FIG. 6 is a view illustrating an embodiment in which a command sequence input to a mobile robot, according to an embodiment of the inventive concept.

### DETAILED DESCRIPTION

Advantage points and features of the inventive concept and a method of accomplishing thereof will become apparent from the following description with reference to the following figures, wherein embodiments will be described in detail with reference to the accompanying drawings. The inventive concept, however, may be embodied in various different forms, and should not be construed as being limited only to the illustrated embodiments. Rather, these embodiments are provided as examples so that the inventive concept will be thorough and complete, and will fully convey the concept of the inventive concept to those skilled in the art. The inventive concept may be defined by scope of the claims. Meanwhile, the terminology used herein to describe embodiments of the inventive concept is not intended to limit the scope of the inventive concept.

The terminology used herein is for the purpose of describing embodiments and is not intended to limit the inventive concept. As used herein, the singular terms “a,” “an” and “the” are intended to include the plural forms as well, unless the context clearly indicates otherwise. The terms “comprises” and/or “comprising” used herein does not exclude presence or addition of one or more other elements, in addition to the aforementioned elements. The same reference numerals denote the same elements throughout the specification. As used herein, the term “and/or” includes any and all combinations of one or more of the associated components. It will be understood that, although the terms “first”, “second”, etc., may be used herein to describe various components, these components should not be limited by these terms. These terms are only used to distinguish one component from another component. Thus, a first component discussed below could be termed a second component without departing from the teachings of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

As illustrated in the figures, spatially relative terms, such as “below”, “beneath”, “lower”, “above”, “upper”, and the like, may be used herein for ease of description to describe the relationship between one component and other components. It will be understood that the spatially relative terms are intended to encompass different orientations of the components in use or operation in addition to the orientation depicted in the figures. For example, when inverting a component shown in the figures, a component described as “below” or “beneath” of another component may be placed “above” another element. Thus, the exemplary term “below” may include both downward and upward directions. The components may also be oriented in different directions, and thus the spatially relative terms may be interpreted depending on orientation.

Hereinafter, according to an embodiment of the inventive concept, a mobile robot including a programmable input module will be described with reference to accompanying drawings.

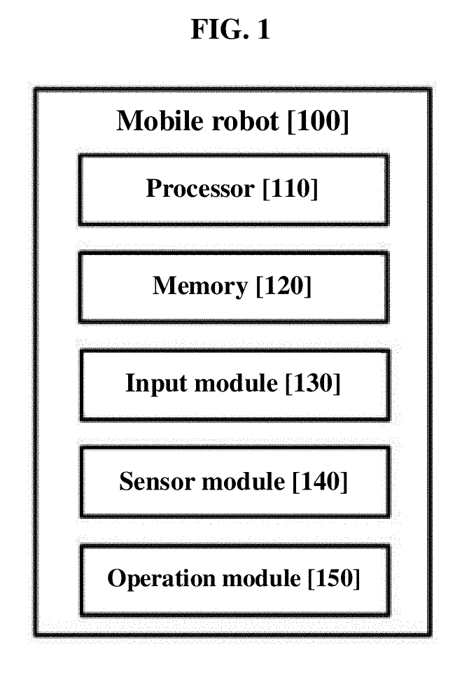

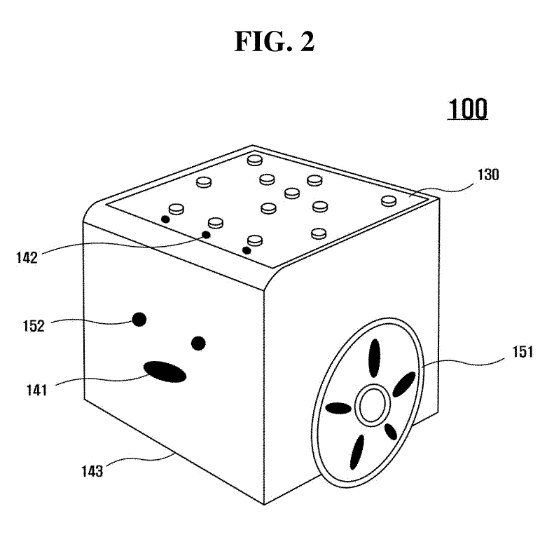

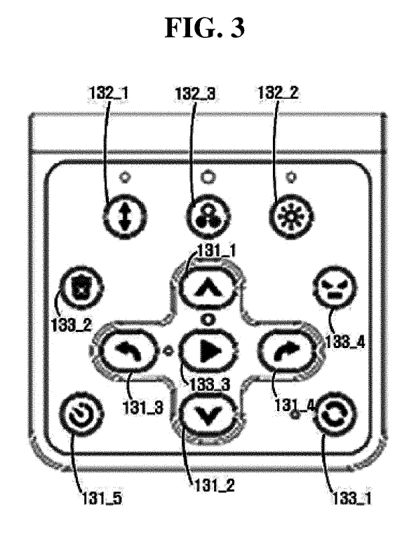

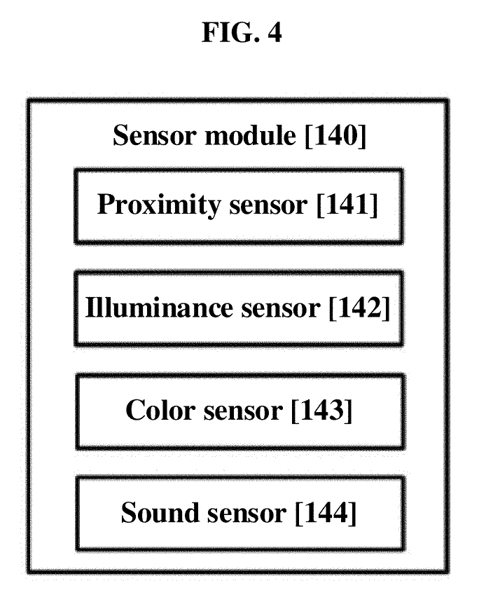

A mobile robot 100 according to an embodiment of the inventive concept includes a programmable input module 130; when a user enters a command through the input module 130 to perform programming, a processor 110 may execute a command sequence including commands received from the input module 130, and thus may operate the mobile robot 100. Hereinafter, the mobile robot 100 according to an embodiment of the inventive concept will be described with reference to FIGS. 1 to 4. FIG. 1 is a block diagram illustrating a configuration of a mobile robot, according to an embodiment of the inventive concept. FIG. 2 is a perspective view of a mobile robot, according to an embodiment of the inventive concept. FIG. 3 is a schematic diagram of an input module of a mobile robot, according to an embodiment of the inventive concept. FIG. 4 is a block diagram illustrating a configuration of a sensor module of FIG. 1.

Referring to FIG. 1, the mobile robot 100 may include the processor 110, a memory 120, the input module 130, a sensor module 140, and an operation module 150. However, in some embodiments, the mobile robot 100 may include components more or fewer than the components illustrated in FIG. 1.

The processor 110 may control the mobile robot 100, and may control the memory 120, the input module 130, the sensor module 140, and the operation module 150. In particular, the processor 110 may execute the command sequence including commands received from the input module 130, may execute the commands received from the input module 130, and may execute a program command stored in the memory 120. Herein, the processor 110 may be a central processing unit (CPU) or may mean a dedicated processor performing methods according to various embodiments of the inventive concept.

The memory 120 may store information necessary for the operation of the mobile robot 100 and may store the program command. Furthermore, the predetermined command sequence necessary when the mobile robot 100 operates in a second mode in which the mobile robot 100 is controlled depending on the execution of the predetermined command sequence may be stored instead of a first mode in which the mobile robot 100 is controlled depending on the execution of the predetermined command sequence including the commands received from the input module 130.

In the meantime, the type of the memory 120 may not be limited, and may be implement with at least one of, for example, a volatile storage medium and a nonvolatile storage medium.

The input module 130 may be used when receiving the command for programming the mobile robot 100 from the user. Herein, the command for programming may include an action command associated with the operation of the mobile robot 100, a condition command associated with a condition for executing the action command, and a control command for controlling the command input to the mobile robot, and the action command, the condition command, and the control command will be described in detail.

In some embodiments, the input module 130 may include a plurality of buttons for inputting the action command, the condition command, and the control command. Referring to FIG. 2, the plurality of buttons may be formed on at least one surface of the mobile robot 100. That is, according to the mobile robot 100 according to an embodiment of the inventive concept, since the input module 130 for programming is formed on the mobile robot 100, programming education may be possible even though a separate computer for programming training is absent.

Herein, a button may be a physical button configured to receive a physical input, such as the user's click or a push, as an embodiment of the input module 130. However, an embodiment may not be limited thereto. The button may be a touch-type button configured to receive an electrostatic input such as the user's touch. According to an embodiment of the inventive concept, the user may do programming by pushing a button for inputting a command necessary, when the user performs programming, from among a plurality of buttons for inputting the action command, the condition command, and the control command.

In some embodiments, the input module 130 may include a proximity sensor (not illustrated) or a camera (not illustrated) so as to recognize the user's gesture or the movement of the user's body including eyes, and the processor 110 may determine that a command corresponding to the recognized gesture or the movement of the body is input. According to an embodiment of the inventive concept, the user may do programming by taking a gesture or the movement of the body corresponding to a command, which the user wants to enter, from among the action command, the condition command, and the control command.

In some embodiments, the input module 130 may include a speaker (not illustrated) so as to recognize the input sound including the user's voice, and the processor 110 may determine that the command corresponding to the characteristic of the recognized sound is input. When the processor 110 is equipped with an artificial intelligence voice engine and speech recognition is enabled, the processor 110 may determine that a command corresponding to the user's speech (voice) is input. According to an embodiment of the inventive concept, the user may do programming by generating the sound (or voice) corresponding to a command, which the user wants to enter, from among the action command, the condition command, and the control command.

A command capable of being input through the input module 130 will be input.

First, the action command may be a command associated with the operation of the mobile robot 100, and the operation module 150 described below may operate depending on the input action command.

The action command may include at least one of a go-forward command to move the mobile robot 100 forward by a determined distance or to move the mobile robot 100 forward during a determined time, a go-backward command to move the mobile robot 100 backward by the determined distance or to move the mobile robot 100 backward during the determined time, a left turn command to move the mobile robot 100 to the left by the determined distance or to move the mobile robot 100 to the left during the determined time, a right turn command to move the mobile robot 100 to the right by the determined distance or to move the mobile robot 100 to the right during the determined time, and a standby command to cause the mobile robot 100 to remain in position without moving during the determined time. However, the action command is not limited thereto and may be added when the action command is associated with the operation of the mobile robot 100; and the number of action commands may increase as the function of the operation module 150 increases.

For example, in the case where the mobile robot 100 moves on a floor grid, when the go-forward command, the go-backward command, the left turn command, and the right turn command are executed by the processor 110, the mobile robot 100 may move forward, backward, leftward and rightward by one step on a floor grid.

However, in some embodiments, in the go-forward command, the go-backward command, the left turn command, and the right turn command, the determined time or determined distance for movement may not be fixed and the determined time or determined distance may be programmed and determined through the input module 130. Likewise, the determined time when the mobile robot 100 does not move and remains in position through the standby command may be also be programmed and determined through the input module 130.

In some embodiments, the action command may further include a light emitting module command for turning on and off a light emitting module 152, for changing the color of the light emitting module 152, or for causing the light emitting module 152 to flicker by blinking or dimming.

In some embodiments, the left turn command may be a command to rotate the mobile robot 100 to the left by a determined angle or during a determined time, and the right turn command may be a command to rotate the mobile robot 100 to the right by a determined angle or during a determined time. However, in the left turn command and the right turn command, the determined time or the determined angle for movement may not be fixed and the determined time or the determined angle may be programmed and determined through the input module 130.

Meanwhile, in the case where the input module 130 is composed of a plurality of buttons, the plurality of buttons may include a button for inputting at least one action command of the go-forward command, the go-backward command, the left turn command, the right turn command, and the standby command. Referring to FIG. 3, the input module 130 may include a go-forward command button 131_1, a go-backward command button 131_2, a left turn command button 131_3, a right turn command button 131_4, and a standby command button 131_5, and a picture for intuitively understanding the attribute of the button may be drawn on each button.

According to the determined rule the mobile robot 100 according to an embodiment of the inventive concept, a plurality of action commands may be input sequentially. When the command sequence including the plurality of action commands is executed by the processor 110, the plurality of action commands may be executed sequentially. Besides, the action command may be input after the condition command is input or may be input before a repeat command in the control command is input. Even though the condition command or the repeat command is not input, the action command may be input exclusively.

Afterwards, the condition command may be a command associated with the condition for executing the action command, and whether the condition is satisfied may be determined based on the sensed result of the sensor module 140. That is, as described above, the action command may be input after the condition command is input. In the case where it is determined that the condition according to the condition command is satisfied, based on the sensed result of the sensor module 140, the action command input after the condition command is input may be executed by the processor 110.

The condition command may include at least one of a proximity condition command having a condition for executing the action command in which another object is located within a determined distance from the mobile robot 100, an illuminance condition command having a condition for executing the action command in which the change in the ambient brightness of the mobile robot 100 is not less than the degree of the determined change, a color condition command having a condition for executing the action command in which the ambient color of the mobile robot 100 is the determined color, and a sound condition command having a condition for executing the action command in which the magnitude change of the ambient sound of the mobile robot 100 is not less than the degree of the determined change. However, the condition command is not limited thereto and may be added when the detectable information is present in the mobile robot 100; and the number of condition commands may increase as the function of the sensor module 140 increases.

For example, the user may cause the action command to be executed through the proximity condition command by the processor 110 in the case where an obstacle is detected within a determined distance from the mobile robot 100; the user may cause the action command to be executed through the illuminance condition command by the processor 110 in the case where the current brightness increases or decrease by a certain level or more; the user may cause the action command to be executed through the color condition command by the processor 110 in the case where a predetermined color is detected among red, orange, yellow, green, blue, violet, black, or the like; and the user may cause the action command to be executed through the sound condition command by the processor 110 in the case where the magnitude of the input sound is changed.

Meanwhile, in the case where the input module 130 is composed of a plurality of buttons, the plurality of buttons may include a button for inputting at least one condition command of the proximity condition command, the illuminance condition command, the color condition command, and the sound condition command. Referring to FIG. 3, the input module 130 may include a proximity condition command button 132_1, an illuminance condition command button 132_2, a color condition command button 132_3, and a sound condition command button (not illustrated), and a picture for intuitively understanding the attribute of the button may be drawn on each button.

In some embodiments, the color condition command button 132_3 may include a plurality of buttons, and the number of color condition command buttons 132_3 may be the same as the number of colors capable of being recognized by a color sensor 143. Furthermore, in some embodiments, the color condition command for a specific color may be input by successively pressing the color condition command button 132_3. For example, when the color condition command button 132_3 is pressed once in rainbow color order, the processor 110 may recognize that the color condition command associated with red is input; when the color condition command button 132_3 is pressed twice, the processor 110 may recognize that the color condition command associated with orange is input.

Finally, the control command is a command for controlling the command input to the mobile robot 100. The control command may include at least one of a repeat command, a delete command, and an execution command.

The function of the repeat command will be described. In the case where the processor 110 executes a command sequence including the repeat command, the processor 110 may repeat the action command input from the input module 130 before the repeat command is input.

In some embodiments, in the case where the processor 110 executes the command sequence including the repeat command, when a plurality of action commands are input from the input module 130 before the repeat command is input, the processor 110 may sequentially execute the plurality of action commands input from the input module 130 in input order before the repeat command is input, and may repeat the sequential execution.

In some embodiments, in the case where the processor 110 executes the command sequence in which the condition command is input after the repeat command is input, when the processor 110 determine that the condition of the condition command input from the input module 130 is satisfied based on the sensed result of the sensor module 140 while the processor 110 repeats the action command input from the input module 130 before the repeat command is input, the processor 110 may execute the action command input from the input module 130 after the condition command is input. That is, in the case where the condition of the condition command is satisfied, the action command positioned after the condition command may be executed by the processor 110, prior to the action command positioned before the repeat command.

However, after the condition command is input and then the processor 110 executes the action command input from the input module 130, the processor 110 may repeat the action command input from the input module 130 before the repeat command is input. That is, after the action command positioned after the condition command is executed once by the processor 110, the action command positioned before the repeat command may be executed by the processor 110.

The function of the delete command will be described. When the delete command is input from the input module 130, the processor 110 may delete all commands input from the input module 130 before the delete command is input. Accordingly, for the purpose of creating a new command sequence, the user may delete a previously input command sequence by inputting the delete command through the input module 130.

The function of the execution command will be described. When an execution command is input from the input module 130, the processor 130 may execute the command sequence or may pause the execution of the command sequence. In particular, when the execution command is input from the input module 130, the processor 110 executes the command sequence. When the execution command is input from the input module 130 while the command sequence is executed by the processor 110, the processor 110 may pause the execution of the command sequence. Moreover, when the execution command is input from the input module 130 in a state where the execution of the command sequence is paused by the processor 110, the processor 110 may execute the command sequence again.

Meanwhile, in the mobile robot 100 according to an embodiment of the inventive concept, the command sequence may be defined as including at least one command input before the execution command is input after the delete command is input from the input module 130. However, in the case where the mobile robot 100 is initialized by the power on/off and other reasons, the command sequence may be defined as including at least one command input from the input module 130 before the mobile robot 100 is input after the initialization state of the execution command.

In some embodiments, the control command may further include a mode change command for changing the control mode of the mobile robot 100.

The mobile robot 100 may include a first mode in which the mobile robot 100 is controlled depending on the execution of the command sequence including commands input from the input module 130 and a second mode in which the mobile robot 100 is controlled depending on the execution of the determined command sequence.

The second mode is a mode controlled depending on the execution of the determined command sequence regardless of the command input from the input module 130, and may be, for example, a line tray mode. In the line tray mode, the processor 110 may control the mobile robot 100 to move along a line by using the color sensor 143 positioned on the bottom surface of the mobile robot 100.

In some embodiments, the second mode may be a palm-follower mode. In the palm-follower mode, in the case where a palm is sensed by a proximity sensor 141, the processor 110 may control the mobile robot 100 to move along the palm.

In some embodiments, the second mode may be a random mode. In the random mode, the processor 110 may execute a command sequence generated by randomly arranging the condition command and the action command. As such, the operation of the mobile robot 100 and the condition for the operation may be selected randomly.

In this situation, whenever the mode change command is input from the input module 130, the processor 110 may alternately operate in a first mode in which the mobile robot 100 is controlled depending on the execution of the command sequence including commands input from the input module 130 and in a second mode in which the mobile robot 100 is controlled depending on the execution of the determined command sequence.

According to the mobile robot 100 according to an embodiment of the inventive concept, the user may recognize that the mobile robot 100 is a play tool in addition to the training material for programming, and thus the user may be more interested in the programming course using the mobile robot 100.

Meanwhile, in the case where the input module 130 is composed of a plurality of buttons, the plurality of buttons may include a button for inputting at least one control command of the repeat command, the delete command, the execution command, and the mode change command. Referring to FIG. 3, the input module 130 may include a repeat command button 133_1, a delete command button 133_2, an execution command button 133_3, and a mode change command button 133_4, and a picture for intuitively understanding the attribute of the button may be drawn on each button.

The sensor module 140 may sense the ambient change of the mobile robot 100. In the case where the condition command is input through the mobile robot 100, the sensor module 140 may be used to determine whether the condition according to the input condition command is satisfied. In particular, the processor 110 may determine whether the condition for executing the action command is satisfied, based on the sensed result of the sensor module 140.

Referring to FIG. 4, the sensor module 140 may include at least one of the proximity sensor 141, an illuminance sensor 142, the color sensor 143, and a sound sensor 144. However, in some embodiments, the sensor module 140 may be configured to include components more or fewer than the components illustrated in FIG. 4.

The proximity sensor 141 may sense whether another object is present within a determined distance from the mobile robot 100. For example, the proximity sensor 141 is disposed on the front surface of the mobile robot 100 and may check an obstacle positioned in front of the mobile robot 100. However, in some embodiments, the proximity sensor 141 may be disposed on the rear surface, the left-side surface, or the right-side surface of the mobile robot 100.

In some embodiments, the proximity sensor 141 may be an inductive proximity sensor or a capacitive proximity sensor, or an ultrasonic proximity sensor that calculates the distance from the obstacle by emitting the ultrasonic wave to calculate a time period during which the reflected wave returns. However, the type of the proximity sensor 141 is not limited thereto.

In some embodiments, the determined distance being the sensing range of the proximity sensor 141 may be adjusted depending on the user's settings or programming. For example, the user may connect a user terminal to the mobile robot 100 through wireless communication such as Bluetooth or the like, and the user may control the determined distance, which is the sensing range of the proximity sensor 141, by performing programming using the user terminal.

The illuminance sensor 142 may sense the ambient brightness of the mobile robot 110 and may cause the processor 110 to recognize a change in the ambient brightness of the mobile robot 110. For example, the illuminance sensor 142 may be disposed on the upper surface of the mobile robot 110 such that the illuminance sensor 142 senses the light well. However, the arrangement location of the illuminance sensor 142 is not limited thereto.

In some embodiments, the illuminance sensor 142 may be a sensor of which the resistance value varies with the intensity of the measured light, but the type of the illuminance sensor 142 is not limited thereto.

The color sensor 143 senses the ambient color of the mobile robot 100. For example, the color sensor 143 may recognize a color such as red, orange, yellow, green, blue, violet, or black, but the color that the color sensor 143 is capable of recognizing is not limited thereto. For example, the color sensor 143 may be disposed on the bottom surface (or a lower surface) of the mobile robot 100. In this case, since the color sensor 143 is capable of recognizing a line, the mobile robot 100 may function as a line tracer.

The sound sensor 144 may sense the magnitude of the ambient sound of the mobile robot 100 and may cause the processor 110 to recognize a change in the magnitude of the ambient sound of the mobile robot 100. The location at which the sound sensor 144 is disposed on the mobile robot 110 may not be limited.

In the case where the processor 110 executes a command sequence including commands input from the input module 130, the operation module 150 operates depending on the action command input from the input module 130.

For example, referring to FIG. 2, the operation module 150 may include a wheel 151 and the light emitting module 152. However, the components included in the operation module 150 may be implemented to be more or fewer than the components illustrated in FIG. 2. In some embodiments, the operation module 150 may further include, but is not limited to, a speaker (not shown) or a display (not illustrated).

The wheel 151 may move the mobile robot 100 forward, backward, leftward, and rightward depending on the action command included in the command sequence, and the light emitting module 152 may flicker by blinking or dimming depending on the action command included in the command sequence.

The speaker (not illustrated) may output the determined sound depending on the action command included in the command sequence.

The display (not illustrated) may output necessary information depending on the action command included in the command sequence. For example, the display (not illustrated) may display information processed by the mobile robot 100, information about the input command, battery level information, and the like, but the information output by the display (not illustrated) is not limited thereto.

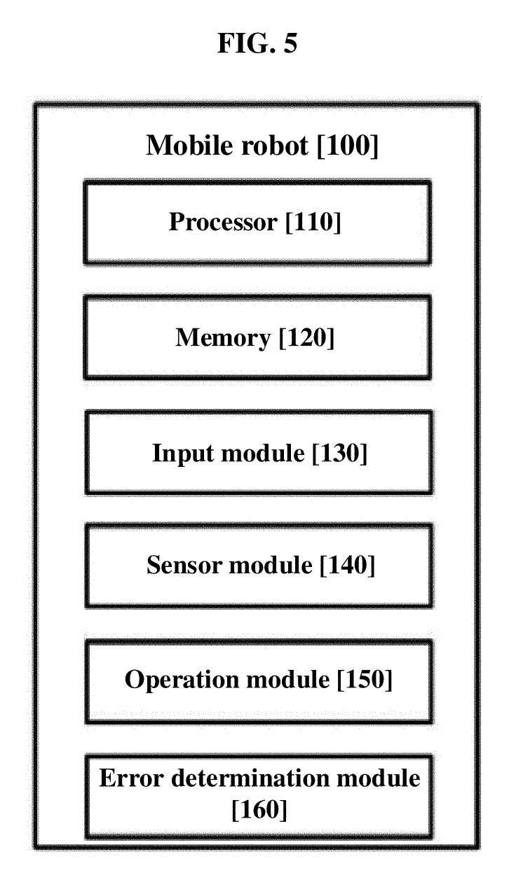

Hereinafter, a mobile robot according to another embodiment of the inventive concept will be described with reference to FIG. 5. However, the difference from a mobile robot according to an embodiment of the inventive concept illustrated in FIG. 1 will be described mainly. FIG. 5 is a block diagram illustrating a configuration of a mobile robot, according to another embodiment of the inventive concept.

The mobile robot 100 according to another embodiment of the inventive concept may further include an error determination module 160 for determining whether a command input from the input module 130 conforms to a determined rule.

In the case where it is determined by the error determination module 160 that the input command does not conform to the determined rule, the processor 110 may notify a user by operating the operation module 150 without including the command in the command sequence.

The mobile robot 100 according to the present embodiment may not include a display for allowing the user to check the input command. In some cases, it is difficult for the user to know whether the command input by the user conforms to a determined rule for programming

To solve the problem, the mobile robot 100 may include the error determination module 160; in the case where it is determined that the command input through the input module 130 does not conforms to the determined rule (e.g., in the case where the repeat command is input twice in one command sequence), the mobile robot 100 may notify the user that the corresponding command has been input incorrectly through the operation module 150.

In addition, the processor 110 may give the user a chance to enter the correct command again by excluding the incorrectly input command in the command sequence.

In some embodiments, in the case where the input module 130 includes a plurality of buttons for inputting the action command, the condition command, and the control command and the plurality of buttons is formed on at least one surface of the mobile robot 100, the processor 110 may visually distinguish one button for inputting a command that satisfies a determined rule when the command is input at the current time and another button for inputting a command that does not satisfy a determined rule when the command is input at the current time.

In particular, the processor 110 may provide a guide to the user such that the user intuitively learns the determined rules for programming and enters a command depending on to a determined rule.

To this end, the processor 110 may cause only the button for inputting a command satisfying the determined rule to emit light when the command is input at the current time and may distinguish the button from a button for inputting a command which does not satisfy the determined rule when the command is input at the current time, and thus the processor 110 may induce the user to enter a command conforming to the determined rule. Furthermore, through this process, the user may intuitively learn the determined rule for programming.

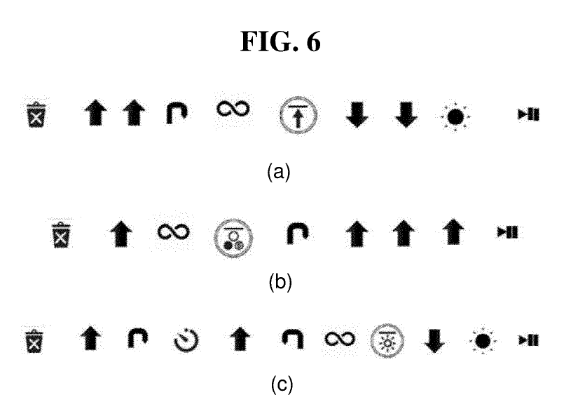

FIG. 6 is a view illustrating an embodiment in which a command sequence input to the mobile robot 100 of the inventive concept.

Referring to (a) of FIG. 6, the mobile robot 100 according to an embodiment of the inventive concept may receive a delete command from a user. In this case, the mobile robot 100 may delete all the commands input before the delete command is input.

After receiving the delete command, the mobile robot 100 may receive a go-forward command twice, may receive a right turn command once, may receive a repeat command once, may receive a proximity condition command once, may receive a go-backward command twice, may receive a light emitting module command once, and may receive an execution command

The mobile robot 100 to which the execution command is input may repeatedly perform an operation of going forward twice by the determined distance or during the determined time based on the command received from the user and an operation of moving to the right by the determined distance or during the determined time based on the command received from the user.

While the operation is repeatedly performed, in the case where the proximity sensor 141 included in the mobile robot 100 recognizes that an object is present within a determined distance, based on the command received from the user, the mobile robot 100 may go backward twice by the determined distance or during the determined time based on the command received from the user, and may turn on the light emitting module 152 under a condition determined based on the command received from the user.

In the case where the input operation is completed after a proximity condition command is input, the mobile robot 100 may repeatedly perform an operation of going forward twice by the determined distance or during the determined time based on the command received from the user and moving to the right by the determined distance or during the determined time based on the command received from the user, which is an existing repeat operation, again.

In the case where the proximity condition is satisfied again during the corresponding operation, the execution of an operation of again performing an operation input after the proximity condition command is input and the existing repeated operation may be repeated.

Referring to (b) of FIG. 6, the mobile robot 100 according to an embodiment of the inventive concept may receive a delete command from a user. In this case, the mobile robot 100 may delete all the commands input before the delete command is input.

After receiving the delete command, the mobile robot 100 may receive a go-forward command once, may receive a repeat command once, may receive a color condition command once, may receive a right turn command once, may receive a go-forward command three times, and may receive an execution command.

The mobile robot 100 to which the execution command button 133_3 is input may repeatedly perform an operation of going forward once by a determined distance or during a determined time based on the command received from the user.

While the operation is repeatedly performed, in the case where the color sensor 143 included in the mobile robot 100 recognizes the color generated based on the command received from the user, the mobile robot 100 may go forward three times by the determined distance or during the determined time based on the command received from the user.

In the case where the execution of a command input after a color condition command is input is completed, the mobile robot 100 may repeatedly perform an operation of going forward once, which is an existing repeat operation, by the determined distance or during the determined time based on the command received from the user.

When the condition of the color condition command is satisfied again during the corresponding operation, the execution of an operation of again performing an operation input after the proximity condition command is input and the existing repeated operation may be repeated.

Referring to (c) of FIG. 6, the mobile robot 100 according to an embodiment of the inventive concept may receive a delete command from a user. In this case, the mobile robot 100 may delete all the commands input before the delete command is input.

After receiving the delete command, the mobile robot 100 may receive a go-forward command once, may receive a right turn command once, may receive a standby command once, may receive a go-forward command once, may receive a left turn command once, may receive a repeat command once, may receive an illuminance condition command once, may receive a go-backward command once, may receive a light emitting module command once, and may receive an execution command.

The mobile robot 100 to which the execution command button 133_3 is input may go forward once by the determined distance or during the determined time based on the command received from the user, may move to the right by the determined distance or during the determined time based on the command received from the user, may stand by during the determined time based on the command received from the user, may go forward once by the determined distance or during the determined time based on the command received from the user, and may move to the left by the determined distance or during the determined time based on the command received from the user.

While the operation is repeatedly performed, in the case where the illuminance sensor 142 included in the mobile robot 100 recognizes an illuminance change that is not less than the reference generated based on the command received from the user, the mobile robot 100 may go backward once by the determined distance or during the determined time based on the command received from the user, and may turn on the light emitting module 152 under a condition determined based on the command received from the user.

In the case where an operation input after an illuminance condition command is input is completed, the mobile robot 100 may repeatedly perform an operation of going forward once by the determined distance or during the determined time based on the command received from the user, moving to the right by the determined distance or during the determined time based on the command received from the user, standing by during the determined time based on the command received from the user, going forward once by the determined distance or during the determined time based on the command received from the user, and moving to the left by the determined distance or during the determined time based on the command received from the user, which is an existing repeated operation.

In the case where the condition of the illuminance condition command is satisfied again during the corresponding operation, the execution of an operation of again performing an operation input after the proximity condition command is input and the existing repeated operation may be repeated.

The steps of a method or algorithm described in connection with the embodiments of the inventive concept may be embodied directly in hardware, in a software module executed by hardware, or in a combination thereof. The software module may reside on a Random Access Memory (RAM), a Read Only Memory (ROM), an Erasable Programmable ROM (EPROM), an Electrically Erasable Programmable ROM (EEPROM), a Flash memory, a hard disk, a removable disk, a CD-ROM, or a computer readable recording medium in any form known in the art to which the inventive concept pertains.

According to an embodiment of the inventive concept, a user may perform intuitively programming through an input module provided by a mobile robot of the inventive concept even though not using complex programming tools.

In addition, according to an embodiment of the inventive concept, since a programming device and the mobile robot are integrated, programming may be educated even without a separate computer for programming training.

Furthermore, according to an embodiment of the inventive concept, since it is possible to determine whether the condition according to the condition command is satisfied using the sensor module included in the mobile robot, it is possible to train the condition command.

In addition, according to an embodiment of the inventive concept, users may be interested in programming that is complex and uninteresting.

The effects of the inventive concept are not limited to the aforementioned effects, and other effects not mentioned herein will be clearly understood from the following description by those skilled in the art to which the inventive concept pertains.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A mobile robot including a programmable input module, comprising:
a processor configured to control the mobile robot;
an input module configured to receive a command for programming the mobile robot from a user, wherein the command for programming includes an action command associated with an operation of the mobile robot, a condition command associated with a condition for executing the action command, and a control command for controlling a command input to the mobile robot;
a sensor module configured to sense an ambient change of the mobile robot, wherein the processor determines whether the condition for executing the action command is satisfied, based on the sensed result of the sensor module; and
an operation module configured to operate depending on the action command input from the input module when the processor executes a command sequence including a command input from the input module,
wherein the control command includes a repeat command, and
wherein the processor repeats the execution of the action command input from the input module before the repeat command is input.

2. The mobile robot of claim 1, wherein when the processor executes the command sequence, when a plurality of action commands are input from the input module before the repeat command is input, the processor sequentially executes the plurality of action commands input from the input module before the repeat command is input, in input order and repeats the sequential execution.

3. The mobile robot of claim 1, wherein when the processor executes the command sequence, when determining that a condition of the condition command input from the input module is satisfied, based on the sensed result of the sensor module, the processor executes the action command input from the input module after the condition command is input.

4. The mobile robot of claim 3, wherein when the processor executes the command sequence, after executing the action command input from the input module after the condition command is input, the processor repeatedly executes the action command input from the input module before the repeat command is input.

5. The mobile robot of claim 1, wherein the control command further includes a delete command and an execution command,
wherein when the delete command is input from the input module, the processor deletes all commands input from the input module before the delete command is input,
wherein when the execution command is input from the input module, the processor executes the command sequence, and
wherein the command sequence includes at least one command input before the execution command is input after the delete command is input from the input module.

6. The mobile robot of claim 5, wherein when the execution command is input from the input module while the command sequence is executed by the processor, the processor pauses the execution of the command sequence, and
wherein when the execution command is input from the input module in a state where the execution of the command sequence is paused by the processor, the processor executes the execution of the command sequence again.

7. The mobile robot of claim 1, wherein the input module includes a plurality of buttons for inputting the action command, the condition command, and the control command, and
wherein the plurality of buttons are formed on at least one surface of the mobile robot.

8. The mobile robot of claim 7, wherein the action command includes at least one of:
a go-forward command for moving the mobile robot forward by a determined distance or for moving the mobile robot forward during a determined time;
a go-backward command for moving the mobile robot backward by the determined distance or for moving the mobile robot backward during the determined time;
a left turn command for moving the mobile robot to a left by the determined distance or for moving the mobile robot to the left during the determined time;
a right turn command for moving the mobile robot to a right by the determined distance or for moving the mobile robot to the right during the determined time; and
a standby command for causing the mobile robot 100 to remain in position during the determined time, and
wherein the plurality of buttons includes a button for inputting the action command of at least one of the go-forward command, the go-backward command, the left turn command, the right turn command, and the standby command.

9. The mobile robot of claim 7, wherein the condition command includes at least one of:
a proximity condition command having a condition for executing the action command, in which another object is located within a predetermined distance from the mobile robot;
an illuminance condition command having a condition for executing the action command, in which a change in an ambient brightness of the mobile robot is not less than a degree of a determined change;
a color condition command having a condition for executing the action command, in which an ambient color of the mobile robot is a determined color; and
a sound condition command having a condition for executing the action command, in which a magnitude change of an ambient sound of the mobile robot is not less than a degree of a determined change, and
wherein the plurality of buttons includes a button for inputting the condition command of at least one of the proximity condition command, the illuminance condition command, the color condition command, and the sound condition command.

10. The mobile robot of claim 7, wherein the control command further includes at least one of a delete command and an execution command,
wherein when the delete command is input from the input module, the processor deletes all commands input from the input module before the delete command is input,
wherein when the execution command is input from the input module, the processor executes the command sequence or pauses the execution of the command sequence, and
wherein the plurality of buttons includes a button for inputting the control command of at least one of the repeat command, the delete command, and the execution command.

11. The mobile robot of claim 1, wherein the sensor module includes at least one of a proximity sensor, an illuminance sensor, a color sensor, and a sound sensor,
wherein the proximity sensor senses whether another object is present within a determined distance from the mobile robot,
wherein the illuminance sensor senses an ambient brightness of the mobile robot and causes the processor to recognize a change in the ambient brightness of the mobile robot,
wherein the color sensor senses an ambient color of the mobile robot, and
wherein the sound sensor senses a magnitude of an ambient sound of the mobile robot and causes the processor to recognize a change in the magnitude of the ambient sound of the mobile robot.

12. The mobile robot of claim 1, wherein the control command further includes a mode change command for changing a control mode of the mobile robot, and
wherein whenever the mode change command is input from the input module, the processor alternately operates in a first mode in which the mobile robot is controlled depending on the execution of the command sequence including the command input from the input module and in a second mode in which the mobile robot is controlled depending on the execution of a determined command sequence.

13. The mobile robot of claim 1, further comprising:
an error determination module configured to determine whether the command input from the input module satisfies a determined rule,
wherein when it is determined, by the error determination module, that the input command does not satisfy the determined rule, the processor operates the operation module to notify the user of a notification without including a corresponding command in the command sequence.

14. The mobile robot of claim 13, wherein the input module includes a plurality of buttons for inputting the action command, the condition command, and the control command,
wherein the plurality of buttons are formed on at least one surface of the mobile robot, and
wherein the processor visually distinguishes a button for inputting a command that satisfies the determined rule when input at a current time, and another button for inputting a command that does not satisfy the determined rule when input at the current time.
